(19) United States
(12) Patent Application Publication
(10) Pub. No.: US 2017/0142335 A1
(43) Pub. Date: May 18, 2017

(54) IMAGE EVALUATION APPARATUS THAT EVALUATES CONTINUOUSLY PHOTOGRAPHED IMAGES

(71) Applicant: CASIO COMPUTER CO., LTD., Tokyo (JP)

(72) Inventor: Kosuke Matsumoto, Tokyo (JP)

(21) Appl. No.: 15/347,991

(22) Filed: Nov. 10, 2016

(30) Foreign Application Priority Data
Nov. 18, 2015 (JP) 2015-226129

(51) Int. Cl. H04N 5/232

(52) U.S. Cl. CPC H04N 5/23254; H04N 5/23267

(57) ABSTRACT

An image evaluation apparatus is provided with an image evaluation unit. While images are continuously photographed, the image evaluation unit evaluates the photographed images, based on first evaluation criteria. In addition, upon completion of the continuous photography, the image evaluation unit evaluates the evaluated photographed images, further based on second evaluation criteria. As a result, the image evaluation apparatus can appropriately evaluate the continuously photographed images, while achieving a balance between the speed and accuracy in evaluation.

### CROSS-REFERENCE TO RELATED APPLICATION

This application claims the benefit of priority of Japanese Patent Application No. 2015-226129 filed on Nov. 18, 2015 the entire disclosure of which, including the description, claims, drawings, and abstract, is incorporated herein by reference in its entirety.

### BACKGROUND OF THE INVENTION

Field of the Invention

The present invention relates to an image evaluation apparatus and an image evaluation method.

Related Art

Conventionally, as a technique of avoiding missing the best moment, images are continuously photographed (by way of burst capture) in advance, and good photographs are selected therefrom after the photographing. The more images a person photographs, the more complicated the subsequent selection will be; accordingly, for example, Patent Document 1 (Japanese Unexamined Patent Application, Publication No. 2001-8135) discloses a technique, in which evaluation values are added to photographed images at the time of photographing, and subsequently, the photographed images are automatically selected based on the evaluation values.

### SUMMARY OF THE INVENTION

An image evaluation apparatus, comprising

a processor that is configured to:

evaluate photographed images, based on first evaluation criteria, while the images are continuously photographed; and

upon completion of the continuous photography, evaluate the photographed images that have been evaluated based on the first evaluation criteria, further based on second evaluation criteria.

An image evaluation method, comprising the processing of:

evaluating photographed images, based on first evaluation criteria, while images are continuously photographed; and

upon completion of the continuous photography, evaluating the photographed images that have been evaluated based on the first evaluation criteria, further based on second evaluation criteria.

An image evaluation apparatus, comprising

a sensor unit that is configured to acquire information relating to the image evaluation apparatus; and

a processor that is configured to:

select continuously photographed images, based on first evaluation criteria according to the information relating to the image evaluation apparatus acquired by way of the sensor unit; and

select the photographed images from the photographed images that have been selected based on the first evaluation criteria, further through evaluation based on the second evaluation criteria according to content of the photographed images. An image evaluation method executed by an image evaluation apparatus, the method comprising the processing of:

evaluating continuously photographed images, based on first evaluation criteria according to information acquired by way of a sensor unit that is configured to acquire information relating to the image evaluation apparatus; and

selecting the photographed images from the photographed images that have been evaluated based on the first evaluation criteria, further through evaluation based on second evaluation criteria according to content of the photographed images.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

By considering the present application in combination with the following detailed descriptions with the following drawings, deeper understandings of the present application can be obtained.

FIG. 1 is a block diagram illustrating a hardware configuration of an image evaluation apparatus according to an embodiment of the present invention;

FIG. 2 is a functional block diagram illustrating a functional configuration for executing image selection processing among the functional configurations of the image evaluation apparatus of FIG. 1; and

FIG. 3 is a flowchart illustrating a flow of image selection processing executed by the image evaluation apparatus of FIG. 1 having the functional configuration of FIG. 2.

### DETAILED DESCRIPTION OF THE INVENTION

Preferred embodiments of the present invention will hereinafter be described in detail with reference to the attached drawings.

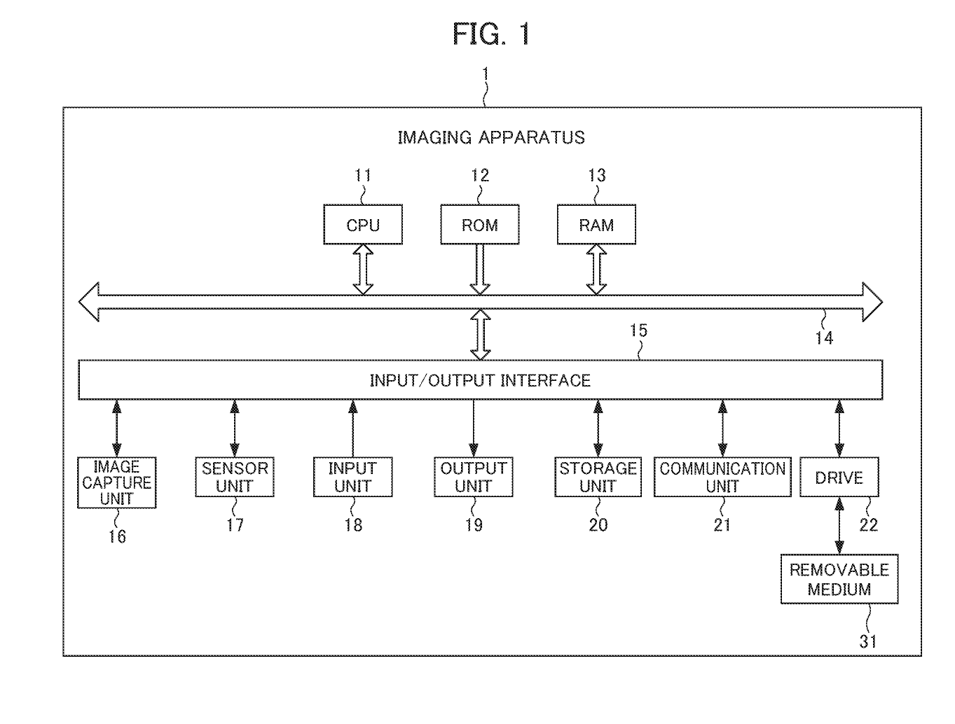

FIG. 1 is a block diagram illustrating a hardware configuration of an image evaluation apparatus according to an embodiment of the present invention. An image evaluation apparatus 1 is configured as, for example, a digital camera.

The image evaluation apparatus 1 includes a CPU (Central Processing Unit) 11, ROM (Read Only Memory) 12, RAM (Random Access Memory) 13, a bus 14, an input/output interface 15, an image capture unit 16, a sensor unit 17, an input unit 18, an output unit 19, a storage unit 20, a communication unit 21, and a drive 22.

The CPU 11 executes various processing according to programs that are recorded in the ROM 12, or programs that are loaded from the storage unit 20 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the sensor unit 17, the input unit 18, the output unit 19, the storage unit 20, the communication unit 21, and the drive 22 are connected to the input/output interface 15.

The image capture unit 16 includes an optical lens unit and an image sensor, which are not shown.

In order to photograph a subject, the optical lens unit is configured by a lens such as a focus lens and a zoom lens for condensing light. The focus lens is a lens for forming an image of a subject on the light receiving surface of the image sensor. The zoom lens is a lens that causes the focal length to freely change in a certain range. The optical lens unit also includes peripheral circuits to adjust setting parameters such as focus, exposure, white balance, and the like, as necessary.

The image sensor is configured by an optoelectronic conversion device, an AFE (Analog Front End), and the like. The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE. The AFE executes a variety of signal processing such as A/D (Analog/Digital) conversion processing of the analog signal. The variety of signal processing generates a digital signal, and an output signal from the image capture unit 16 is output as data of a photographed image. The data of a photographed image is supplied to the CPU 11, an image processing unit (not illustrated) and the like as appropriate, thereby generating a photographed image.

The sensor assembly 17 is configured by various sensors capable of acquiring information about a posture such as acceleration and angular velocity of the apparatus.

The input unit 18 is configured by various buttons, etc. and inputs various information in response to the instruction operations of the user.

The output unit 19 is configured by the display unit, a speaker, and the like, and outputs images and sound.

The storage unit 20 is configured by DRAM (Dynamic Random Access Memory) or the like, and stores data of various images.

The communication unit 21 controls communication to be performed with another device (not illustrated) via a network including the Internet.

A removable medium 31 composed of a magnetic disk, an optical disk, a magneto-optical disk, semiconductor memory or the like is installed in the drive 22, as appropriate. A program read from the removable media 31 by the drive 22 is installed in the storage unit 20 as necessary. In addition, similarly to the storage unit 20, the removable media 31 can store various data such as the data of images stored in the storage unit 20.

The image evaluation apparatus 1 as thus constituted has a function capable of quickly selecting a single optimal image from among a large quantity of images photographed by way of high-speed continuous photography or time-lapse photography (hereinafter referred to as “continuous photography”). The image evaluation apparatus 1 selects images through two stages of: real-time image selection during continuous photography (hereinafter referred to as “high-speed selection”); and image selection after finishing the continuous photography (hereinafter referred to as “low-speed selection”). In the technique of high-speed selection, sensor information from sensors such as an acceleration sensor or a gyro sensor at the time of the respective photography during the continuous photography is analyzed, and images are selected based on circumstances under which the images have been photographed. In the present embodiment, inappropriate images such as blurred images are not selected, based on a result of analyzing the sensor information. In addition, in the technique of low-speed selection, images are analyzed, and selected based on content of the images. In the present embodiment, a single optimal image is selected based on a result of image analysis.

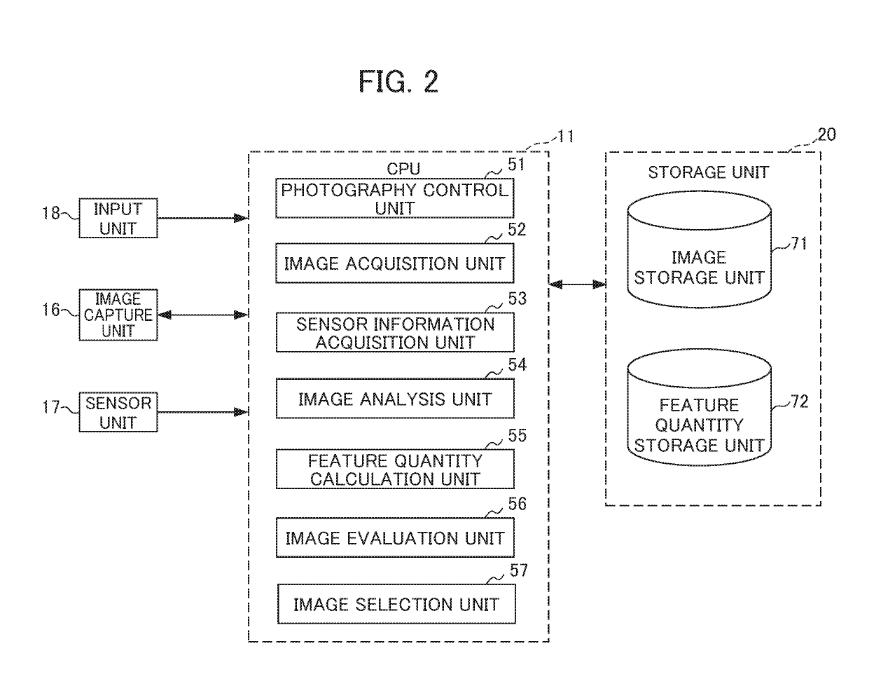

FIG. 2 is a functional block diagram illustrating a functional configuration for executing image selection processing, in relation to the functional configurations of the image evaluation apparatus 1 of FIG. 1. The image selection processing refers to a sequence of processing for selecting a single photographed image from among a large quantity of continuously photographed images.

When performing the image selection processing, as illustrated in FIG. 2, a photography control unit 51, an image acquisition unit 52, a sensor information acquisition unit 53, an image analysis unit 54, a feature quantity calculation unit 55, an image evaluation unit 56, and an image selection unit 57 function in the CPU 11.

Further, an image storage unit 71 and a feature quantity storage unit 72 are provided to an area of the storage unit 20.

The image storage unit 71 stores data of photographed images photographed by way of the image capture unit 16.

The feature quantity storage unit 72 stores: feature quantity calculated based on sensor information acquired from the sensor unit 17 (for example, a photographing state of the image evaluation apparatus 1 (posture of the apparatus in relation to horizontal and elevation angles), an extent of shaking during exposure, camera shake calibration, camera work estimation (panning and tilting estimation, etc.), camera angle estimation (vertical estimation), a behavior estimation result, etc.); and feature quantity calculated based on a result of image analysis (for example, presence or absence of a face, a position of a face, a number of faces, personal identification, a position, size and contrast of an attention region, etc.).

The photography control unit 51 controls the image capture unit 16 to photograph. In the present embodiment, the photography control unit 51 controls the image capture unit 16 to, for example, continuously photograph at 30 fps for five seconds, during which 150 images are photographed in total.

The image acquisition unit 52 acquires photographed images photographed by way of the image capture unit 16.

The sensor information acquisition unit 53 acquires sensor information at the time of the photographing corresponding to the photographed images acquired from the sensor unit 17. During the high-speed selection, the sensor information acquisition unit 53 acquires sensor information corresponding to the continuous photography, from the sensor unit 17. Specifically, from the sensor unit 17, the sensor information acquisition unit 53 acquires a photographing state of the image evaluation apparatus 1 (a posture of the apparatus in relation to the horizontal and elevation angles), an extent of shaking during exposure, camera shake calibration, camera work estimation (panning and tilting estimation, etc.), camera angle estimation (vertical estimation), a behavior estimation result, etc.

The image analysis unit 54 performs image analysis of the photographed images. Results of the image analysis are output, such as, for example, presence or absence of a face, a position of the face, a number of faces, presence or absence of personal identification, a position, size and contrast of an attention region, etc. The image analysis may be performed by using an existing well-known image analysis technology.

The feature quantity calculation unit 55 calculates feature quantity for use in evaluation, based on evaluation criteria according to the sensor information and the image analysis result. For example, in a case in which an extent of shaking during exposure in relation to the sensor information is used as an evaluation criterion, the feature quantity is calculated such that: the feature quantity is higher for an image having a lower extent of shaking, which is likely to result in an appropriate and high-quality image; and the feature quantity is lower for an image having a higher extent of shaking, which is likely to result in an inappropriate and low-quality image. Moreover, in a case in which a photographing state in relation to the sensor information is used as an evaluation criterion, the feature quantity is calculated such that: the feature quantity is higher for an image in a horizontal state, which is likely to result in an appropriate and high-quality image; and the feature quantity is lower for an image in a non-horizontal state, which is likely to result in an inappropriate and low-quality image. In addition, in a case in which presence or absence of a face in relation to the image analysis result is used as an evaluation criterion, the feature quantity is calculated such that: the feature quantity is higher for an image with a face, which is likely to result in an appropriate and high-quality image; and the feature quantity is lower for an image without a face, which is likely to result in an inappropriate and low-quality image. Further, in a case in which a position of an attention region in relation to the image analysis result is used as an evaluation criterion, the feature quantity is calculated such that: the feature quantity is higher for an image with the attention region at the center of the angle of view, which is likely to result in an appropriate and high-quality image; and the feature quantity is lower for an image without the attention region at the center of the angle of view, which is likely to result in an inappropriate and low-quality image. Note that the feature quantity as well as the appropriateness/inappropriateness of the image will vary depending on the desired image.

The image evaluation unit 56 evaluates the photographed images, based on predetermined evaluation criteria. In the present embodiment, during the high-speed selection, in order to prioritize the photography processing, the image evaluation unit 56 evaluates the photographed images, based on first evaluation criteria, with a lower processing load, without affecting the photography processing. Moreover, during the low-speed selection, the image evaluation unit 56 evaluates the photographed images, based on second evaluation criteria, with higher accuracy, without the need to consider the processing load. Note that, in order to further increase the accuracy of the low-speed selection, the image evaluation unit 56 may be configured to perform further evaluation based on the first evaluation criteria.

For the first evaluation criteria, for example, an extent of shaking during exposure and a photographing state are used, which are the feature quantity calculated by way of the feature quantity calculation unit 55, based on the sensor information acquired by way of the sensor information acquisition unit 53 from the sensor unit 17 at the time of the photographing corresponding to the respective photographed images of the continuous photography. In a case in which an extent of shaking during exposure and a photographing state are used as the feature quantity for the first evaluation criteria, for example, the lower the extent of shaking during exposure is, or the closer to horizontal the photographing state is, the higher and more appropriate the image quality will be, the higher the feature quantity will be, the higher the evaluation value will be, and consequently, the higher the evaluation will be.

For the second evaluation criteria, for example, the feature quantity is used, such as presence or absence of a face, a position of the face, a number of faces, presence or absence of personal identification, and a position, size and contrast of an attention region, which are calculated by the feature quantity calculation unit 55, based on a result of analyzing the photographed images by way of the image analysis unit 54. For example, based on conditions such as, a face being present, the face being positioned at the center of the angle of view, the number of faces being higher, personal identification being present, the attention region being positioned closer to the center of the angle of view, the size of the attention region being larger, and the contrast of the attention region being higher, the image quality will be higher, the feature quantity will be higher, a higher evaluation value will be given, and consequently, the evaluation will be higher.

The image selection unit 57 selects the photographed images, based on the evaluation result. Specifically, the image selection unit 57 deselects the photographed images having a lower evaluation, or selects the photographed images having a higher evaluation. More specifically, the image selection unit 57 selects photographed images with a low extent of shaking during exposure, excluding photographed images in a non-horizontal photographing state, in relation to the evaluation result provided by the image evaluation unit 56; or selects a photographed image with the highest feature quantity and evaluation value in relation to the evaluation result provided by the image evaluation unit 56. Further, the image selection unit 57 stores or temporarily stores the selected photographed images into the image storage unit 71. Note that, in the present embodiment, since the photographed images are temporarily stored into the image storage unit 71 in the RAW format, the number of images to be stored is determined in advance.

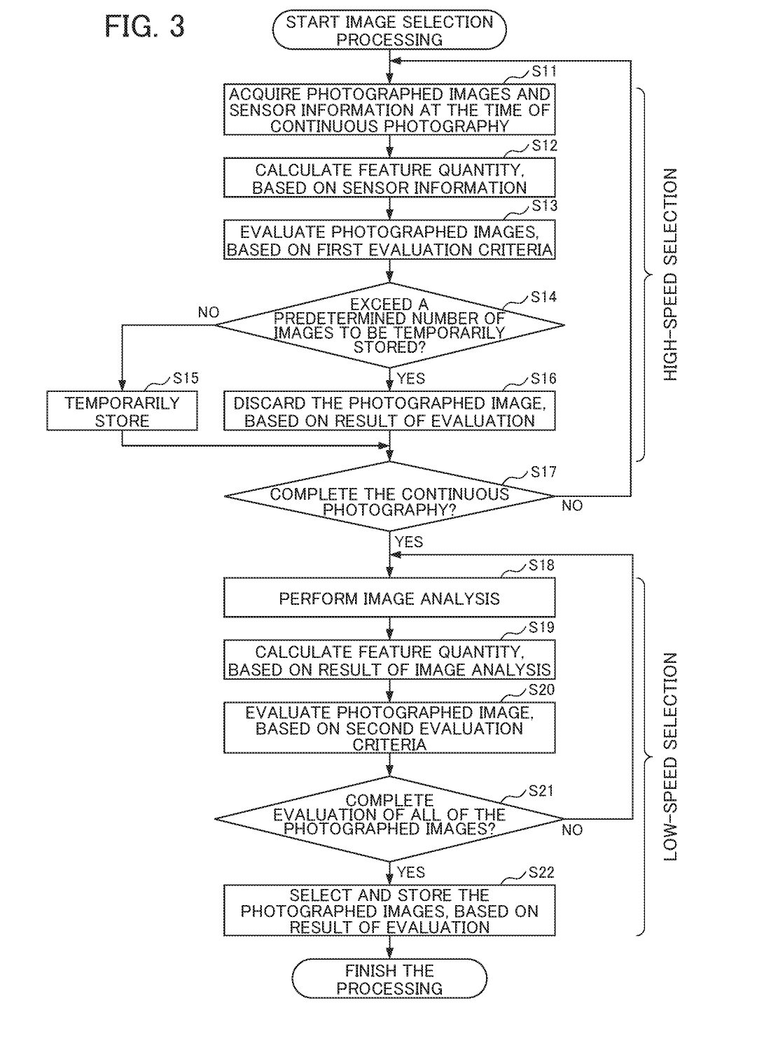

FIG. 3 is a flowchart illustrating a flow of the image selection processing executed by the image evaluation apparatus 1 of FIG. 1 having the functional configuration of FIG. 2. The image selection processing starts by way of a user's operation on the input unit 18 to start the image selection processing. Moreover, as the result of a user's operation on the input unit 18 to start the continuous photography, the photography control unit 51 controls the image capture unit 16 to perform continuous photography. Note that, in the present embodiment, for example, images are continuously photographed at 30 fps for five seconds, during which 150 images are photographed in total. As the result of photographing, the image evaluation apparatus 1 will select one image from 150 photographed images.

In Step S11, the image acquisition unit 52 acquires a photographed image photographed by way of continuous photography. In addition, the sensor information acquisition unit 53 acquires sensor information at the time of photographing corresponding to the photographed image acquired from the sensor unit 17. The sensor information acquisition unit 53 acquires, for example, an extent of shaking during exposure, and a photographing state, from the sensor unit 17.

In Step S12, the feature quantity calculation unit 55 calculates feature quantity, based on the sensor information acquired by way of the sensor information acquisition unit 53. Specifically, the feature quantity calculation unit 55 calculates feature quantity in relation to the extent of shaking during exposure and the photographing state. The calculated feature quantity is stored into the feature quantity storage unit 72.

In Step S13, the image evaluation unit 56 evaluates the acquired photographed image as an evaluation target, based on the first evaluation criteria. Specifically, the image evaluation unit 56 evaluates the photographed image by using the extent of shaking during exposure and the photographing state as the first evaluation criteria, in relation to the feature quantity calculated by way of the feature quantity calculation unit 55. In evaluation, for example, the lower the extent of shaking during exposure is, and the closer to horizontal the photographing state is, the higher the evaluation will be.

In Step S14, the image selection unit 57 determines whether the number of temporarily stored images exceeds a predetermined number of images to be temporarily stored. If the number does not exceed the number of images to be temporarily stored, the determination in Step S14 is NO, and the processing advances to Step S15.

In Step S15, since the number has not reached the number of images to be temporarily stored, the image selection unit 57 temporarily stores the photographed image. Note that the photographed images are temporarily stored into the image storage unit 71 in the RAW format (as a Bayer image). Subsequently, the processing advances to Step S17.

In contrast, if the number exceeds the number of images to be temporarily stored, the determination in Step S14 is YES, and the processing advances to Step S16.

In Step S16, the photographed images are deselected and discarded from the selection by using the evaluation values, based on the evaluation result provided by the image evaluation unit 56, such that the number of images matches the number of images to be temporarily stored. Specifically, the image selection unit 57 compares an evaluation value of a photographed image for the current evaluation, with the evaluation value of the photographed image that has temporarily been stored; if the evaluation value of the temporarily stored photographed image is lower than the evaluation value of the photographed image for the current evaluation, the image selection unit 57 discards the photographed image that has temporarily been stored, and temporarily stores the photographed image for the current evaluation; on the other hand, if the evaluation value of the photographed image for the current evaluation is lower than the evaluation value of the photographed image that has temporarily been stored, the image selection unit 57 discards the photographed image for the current evaluation, without temporarily storing the image. Namely, from among the photographed images that have temporarily been stored, and the photographed image for the current evaluation, a photographed image with the lowest evaluation with the highest extent of shaking during exposure and in a non-horizontal photographing state will be deselected and discarded from the temporary storage target. In this manner, photographed images with low evaluation are discarded in real time during the continuous photography.

In Step S17, the photography control unit 51 determines whether the continuous photography is completed. In the present embodiment, the photography control unit 51 controls the image capture unit 16 to continuously photograph at 30 fps and complete the continuous photograph in five seconds. If the continuous photography is completed, the determination in Step S17 is YES, and the processing advances to Step S18. In contrast, if the continuous photography is not completed, the determination in Step S17 is NO, and the processing returns to Step S11.

In Step S18, the image analysis unit 54 performs image analysis of a photographed image as an evaluation target. Results of the image analysis are output, such as, for example, presence or absence of a face, a position of the face, a number of faces, presence or absence of personal identification, a position, size and contrast of an attention region, etc.

In Step S19, the feature quantity calculation unit 55 calculates feature quantity, based on the image analysis result provided by the image analysis unit 54. Specifically, the feature quantity calculation unit 55 calculates feature quantity in relation to presence or absence of a face, a position of the face, a number of faces, presence or absence of personal identification, a position, size and contrast of an attention region, etc. The calculated feature quantity is stored into the feature quantity storage unit 72.

In Step S20, the image evaluation unit 56 evaluates a photographed image as an evaluation target, based on the second evaluation criteria. Specifically, the image evaluation unit 56 evaluates the photographed image by using the image analysis result provided by the image analysis unit 54, as the second evaluation criteria. In evaluation, for example, the evaluation will be higher for the conditions such as a face being present, the face being positioned closer to the center of the angle of view, the number of faces being higher, personal identification being present, the attention region being positioned closer to the center of the angle of view, the size of the attention region being larger, and the contrast of the attention region being higher.

In Step S21, the image evaluation unit 56 determines whether all of the photographed images have been evaluated. If all of the photographed images have been evaluated, the determination in Step S21 is YES, and the processing advances to Step S22. In contrast, if not all of the photographed images have been evaluated, the determination in Step S21 is NO, and the processing returns to Step S18.

In Step S22, the image selection unit 57 selects a photographed image with the highest evaluation in relation to the evaluation result provided by the image evaluation unit 56, and stores the photographed image into the image storage unit 71 in the format of, for example, JPEG (Joint Photographic Experts Group). As the result, a single photographed image can be selected from the 150 photographed images. Subsequently, the image selection processing is finished.

Therefore, in the present embodiment, the high-speed selection is performed in Steps S11 through S16; and the low-speed selection is performed in Steps S18 through S22.

Note that the embodiment described above may be configured to determine the images by using sensor information during the low-speed selection as well, after completing the photography. In this case, a technique similar to the technique for the high-speed selection may be employed; however, since the low-speed selection does not involve any photographing processing, it may be configured to determine the images by using a technique having a high processing load.

Namely, in relation to the continuous photography, in the case of high-speed continuous photography, or in the case of time-lapse photography while a photographer is engaged in sports activities or the like while wearing the image evaluation apparatus 1 on the body, a large amount of blurred images, oblique images, images without children, etc. may be photographed. In addition, it is difficult for a user to select desired images afterwards from the large quantity of images photographed by way of such functions.

Hypothetically, in the case of performing continuous photography at 30 fps for five seconds, a large quantity of (150) images will be photographed, and conventionally, in the case of selecting a single image therefrom, for example, procedures as follows have been practiced, which have been difficult to achieve.

(1) All of the photographed images photographed during the high-speed continuous photography are stored, and selected afterwards. Since the memory is limited, the capacity to store the photographed images is also limited. Further, it requires time to process, if all of such images are analyzed.
(2) Images are analyzed during the high-speed continuous photography, and are selected in real time. Such processing needs to be completed within the time of the continuous photography (33 ms in the case of 30 fps), within which the analytical processing having a high processing load cannot be completed.

Note that examples of the sensor information for use in image selection may include the following.
Camera shake calibration using a gyro sensor;
Behavior estimation using an acceleration sensor and a gyro sensor;
Camera work estimation using an acceleration sensor and a gyro sensor; and
Vertical estimation (camera angle estimation) using an acceleration sensor or a combination of acceleration sensor +gyro sensor.

Therefore, the image evaluation apparatus 1 of the present embodiment selects a single optimal image from a group of photographed images at high speed through the two-stage selection processing of: real-time screening by analyzing sensor information from various sensors such as an acceleration sensor and a gyro sensor (high-speed selection: selection giving high priority to the photography processing); and post-analysis by way of image analysis (including analysis of the sensor information) (low-speed selection: selection giving high priority to the accuracy of analysis).

Therefore, the image evaluation apparatus 1 can select a single optimal image in a short period of time, from a large group of images photographed in the high-speed continuous photography, through the two-stage selection of: high-speed selection by analyzing the sensor information acquired from sensors such as an acceleration sensor and a gyro sensor; and low-speed selection by way of image analysis (including analysis of the sensor information). The high-speed selection is performed without affecting the processing during the continuous photography, with a low processing load, by using the feature quantity such as an extent of shaking and a camera posture, which can be calculated from the sensor information. In contrast, the low-speed selection is performed by using face detection and composition analysis, which can be calculated from highly accurate images. Therefore, the image evaluation apparatus 1 can select an optimal image, while achieving a balance between the faster processing during the continuous photography, and the improved accuracy in selection after the continuous photography.

The image evaluation apparatus 1 configured as above is provided with the image evaluation unit 56. While the images are continuously photographed, the image evaluation unit 56 evaluates the photographed images, based on the first evaluation criteria. In addition, upon completion of the continuous photography, the image evaluation unit 56 further evaluates the evaluated photographed images, based on the second evaluation criteria. As a result, the image evaluation apparatus 1 can appropriately evaluate the continuously photographed images, while achieving a balance between the speed of continuous photography and the accuracy in evaluation.

Moreover, the image evaluation apparatus 1 is provided with the image selection unit 57. While the images are continuously photographed, the image selection unit 57 selects the photographed images, based on evaluation by way of the image evaluation unit 56. In addition, upon completion of the continuous photography, the image selection unit 57 further selects the photographed images from the selected photographed images, based on evaluation by way of the image evaluation unit 56. As a result, the image evaluation apparatus 1 can select an appropriate image from the continuously photographed images, while achieving a balance between the speed of continuous photography and the accuracy in evaluation.

The processing load of evaluation based on the first evaluation criteria by way of the image evaluation unit 56 is lower than the processing load of evaluation based on the second evaluation criteria by way of the image selection unit 57. As a result, while the images are continuously photographed, the image evaluation apparatus 1 can appropriately evaluate the continuously photographed images by giving high priority to the processing speed, while achieving a balance between the speed of continuous photography and the accuracy in evaluation.

Further, in the image evaluation apparatus 1, the first evaluation criteria are based on information acquired by way of the image evaluation apparatus 1. As a result, in the image evaluation apparatus 1, since the evaluation is based on the information acquired by way of the image evaluation apparatus 1, image analysis or the like is not required, influence on photography processing can be suppressed, and the continuously photographed images can be appropriately evaluated, while achieving a balance between the speed of continuous photography and the accuracy in evaluation.

Moreover, the image evaluation apparatus 1 is further provided with the sensor unit 17 for acquiring a moving state of the apparatus. In addition, the image evaluation apparatus 1 is further provided with the feature quantity calculation unit 55 for calculating feature quantity that is calculated based on the moving state that is acquired by way of the sensor unit 17. Further, in the image evaluation apparatus 1, the first evaluation criteria are based on the feature quantity calculated by way of the feature quantity calculation unit 55. As a result, in the image evaluation apparatus 1, the feature quantity calculated based on the moving state of the apparatus acquired by way of the sensor unit 17 serves as the first evaluation criteria; therefore, for example, an image having a possible camera shake can be determined from external information, and evaluation can be performed in a simple and appropriate manner.

Moreover, in the image evaluation apparatus 1, the second evaluation criteria are based on content of the photographed image. As a result, the image evaluation apparatus 1 can appropriately evaluate the continuously photographed images, while achieving a balance between the speed of continuous photography and the accuracy in evaluation.

Further, the feature quantity calculation unit 55 analyzes the photographed images, and calculates feature quantity, based on predetermined analytical evaluation criteria. In addition, in the image evaluation apparatus 1, the second evaluation criteria are based on feature quantity calculated by way of the image evaluation unit 56. As a result, in the image evaluation apparatus 1, the evaluation based on the second evaluation criteria requiring a high processing load is performed after completing the continuous photography, when the consideration for the photography processing is no longer required; therefore, it is possible to increase the evaluation accuracy, and the continuously photographed images can be appropriately evaluated, while achieving a balance between the speed of continuous photography and the accuracy in evaluation.

Moreover, in the image evaluation apparatus 1, the second evaluation criteria are based on presence or absence, size, number, or position of a subject, to which attention is paid. As a result, in the image evaluation apparatus 1, the second evaluation criteria are based on presence or absence, size, number, or position of a subject, to which attention is paid; therefore, highly accurate evaluation is possible, and the continuously photographed images can be appropriately evaluated, while achieving a balance between the speed of continuous photography and the accuracy in evaluation.

The image evaluation unit 56 evaluates the photographed images by further taking into consideration the first evaluation criteria. As a result, the image evaluation apparatus 1 takes into consideration the first evaluation criteria in addition to the second evaluation criteria; therefore, it is possible to further increase the accuracy, and the continuously photographed images can be evaluated in a more appropriate manner.

The image selection unit 57 does not select any image from the photographed images that have not been selected based on the first evaluation criteria. As a result, since the image evaluation apparatus 1 selects images through the two stages, a more appropriate image can be selected from the continuously photographed images.

In addition, the image evaluation apparatus 1 is further provided with the image storage unit 71 for storing the photographed images selected by way of the image selection unit 57. As a result, the image evaluation apparatus 1 can store the selected photographed images.

The image evaluation apparatus 1 is provided with the image evaluation unit 56, the image selection unit 57, and the sensor unit 17. The image evaluation unit 56 evaluates the continuously photographed images, based on the first evaluation criteria according to the information acquired by way of the sensor unit 17; and the image selection unit 57 selects the photographed images, based on the evaluation provided by the image evaluation unit 56. The image evaluation unit 56 evaluates the photographed images, which have been selected based on the first evaluation criteria, further based on the second evaluation criteria according to the content of the photographed images; and the image selection unit 57 selects the images, based on the evaluation provided by the image evaluation unit 56. As a result, in the image evaluation apparatus 1, the images are evaluated and selected based on the first evaluation criteria with a low processing load, so as to reduce the number of photographed images to be evaluated, and the images are evaluated and selected based on the second evaluation criteria with a high processing load; therefore, the continuously photographed images can be evaluated and selected in an appropriate manner, while achieving a balance between the speed and the accuracy in evaluation.

Further, the image evaluation apparatus 1 is provided with the sensor information acquisition unit 53 and the feature quantity calculation unit 55. The sensor information acquisition unit 53 acquires a moving state of the image evaluation apparatus 1 acquired by way of the sensor unit 17. The feature quantity calculation unit 55 calculates first feature quantity, based on the moving state acquired by way of the sensor information acquisition unit 53. The image evaluation unit 56 evaluates the continuously photographed images, based on the first evaluation criteria according to the first feature quantity calculated by way of the feature quantity calculation unit 55; and the image selection unit 57 selects the images, based on the evaluation provided by the image evaluation unit 56. As a result, in the image evaluation apparatus 1, the feature quantity calculated based on the moving state of the apparatus acquired by way of the sensor unit 17 serves as the first evaluation criteria; therefore, for example, an image having a possible camera shake can be determined from external information, and the images can be selected based on simple and appropriate evaluation.

Moreover, the feature quantity calculation unit 55 calculates the second feature quantity, based on predetermined analytical evaluation criteria. The image evaluation unit 56 selects the photographed images, which have been selected based on the first evaluation criteria, further based on the second evaluation criteria according to the second feature quantity calculated by way of the feature quantity calculation unit 55. As a result, in the image evaluation apparatus 1, the second feature quantity calculated based on the predetermined analytical evaluation criteria serves as the second evaluation criteria; therefore, the images can be selected based on highly accurate evaluation according to the content of the photographed images, which cannot be acquired from the sensor unit 17.

It should be noted that the present invention is not to be limited to the aforementioned embodiments, and that modifications, improvements, etc. within a scope that can achieve the objects of the present invention are also included in the present invention.

The aforementioned embodiments have been illustrated as continuous photography such as high-speed continuous photography or time-lapse photography; however, the photography may be ordinary still image photography or dynamic image photography; and in the case of dynamic image photography, a frame image composing the dynamic image will be the target for image selection.

In addition, in the above-mentioned embodiments, various sensors such as an acceleration sensor and a gyro sensor have been illustrated as examples; however, information from various sensors such as a geomagnetic sensor and a pneumatic pressure sensor may be utilized.

Further, in the above-mentioned embodiments, a single photographed image is eventually selected; however, without limitation to a single image, an arbitrary number of photographed images may be selected, as desired by a user.

Moreover, in the above-mentioned embodiments, in the image evaluation apparatus 1, the feature quantity calculation unit 55 calculates the feature quantity as the second evaluation criteria by using the image analysis result provided by the image analysis unit 54; however, without limitation thereto, the image evaluation apparatus 1 may be configured to perform evaluation with higher accuracy, based on the feature quantity using the result of analyzing the sensor information acquired by way of the sensor information acquisition unit 53.

In addition, in the above-mentioned embodiments, in the image evaluation apparatus 1, a plurality of evaluation levels are set to the second evaluation criteria. For example, a plurality of levels may be set to the evaluation for the low-speed selection; and the apparatus may be configured to classify and store the images, such as images with a high degree of highlight, images that may be too precious to discard, etc. at each level. Specifically, the image selection unit 57 classifies and selects the images at each evaluation level.

Further, the above-mentioned embodiments are configured to select the images in descending order of evaluation in order from an optimal photographed image; however, an embodiment may be configured to deselect unfavorable photographed images of which the evaluation fails to satisfy a predetermined criterion. Moreover, an embodiment may be configured such that the images are deselected in order from unfavorable images, and a planned number of images are eventually selected.

In the embodiments described above, a digital camera has been described as an example of the image evaluation apparatus 1, to which the present invention is applied; however, the present invention is not limited thereto, in particular. For example, the present invention can be applied to any electronic device in general having an image selection processing function. More specifically, for example, the present invention can be applied to a laptop personal computer, a printer, a television receiver, a video camera, a portable navigation device, a cell phone device, a smartphone, a portable gaming device, and the like.

The processing sequence described above can be executed by hardware, and can also be executed by software. In other words, the hardware configurations of FIG. 2 are merely illustrative examples, and the present invention is not limited thereto, in particular. More specifically, the types of functional blocks employed to realize the above-described functions are not particularly limited to the examples shown in FIG. 2, so long as the image evaluation apparatus 1 can be provided with the functions enabling the aforementioned processing sequence to be executed in its entirety. A single functional block may be configured by a single piece of hardware, a single installation of software, or a combination thereof.

In a case in which the processing sequence is executed by software, the program configuring the software is installed from a network or a storage medium into a computer or the like. The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance may include, for example, the ROM 12 shown in FIG. 1, a hard disk included in the storage unit 20 shown in FIG. 1 or the like, in which the program is recorded.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

what is claimed is:

1. An image evaluation apparatus, comprising
a processor that is configured to:
evaluate photographed images, based on first evaluation criteria, while the images are continuously photographed; and
upon completion of the continuous photography, evaluate the photographed images that have been evaluated based on the first evaluation criteria, further based on second evaluation criteria.

2. The image evaluation apparatus according to claim 1, wherein the processor is configured to:
select photographed images through evaluation based on the first evaluation criteria, while the images are continuously photographed; and
upon completion of the continuous photography, select photographed images from the photographed images that have been selected based on the first evaluation criteria, further through evaluation based on the second evaluation criteria.

3. The image evaluation apparatus according to claim 1, wherein a processing load of evaluation based on the first evaluation criteria is lower than a processing load of evaluation based on the second evaluation criteria.

4. The image evaluation apparatus according to claim 1, wherein the processor is configured to:
select photographed images, based on the first evaluation criteria being based on information acquired by way of the image evaluation apparatus, while the images are continuously photographed.

5. The image evaluation apparatus according to claim 4, further comprising an acquisition unit that is configured to acquire a moving state of the image evaluation apparatus,
wherein the processor is configured to:
further calculate first feature quantity, based on the moving state acquired by way of the acquisition unit; and
select photographed images, based on the first evaluation criteria being based on the first feature quantity calculated, while the images are continuously photographed.

6. The image evaluation apparatus according to claim 1, wherein the processor is configured to:
upon completion of the continuous photography, evaluate the photographed images that have been evaluated based on the first evaluation criteria, further based on the second evaluation criteria being based on content of the photographed images.

7. The image evaluation apparatus according to claim 6, wherein the processor is configured to:
further calculate second feature quantity, based on predetermined analytical evaluation criteria, by analyzing the photographed images; and
upon completion of the continuous photography, evaluate the photographed images that have been evaluated based on the first evaluation criteria, further based on the second evaluation criteria being based on the second feature quantity calculated.

8. The image evaluation apparatus according to claim 7, wherein the processor is configured to:
set the second evaluation criteria, based on presence or absence, a size, a number or a position of a subject, to which attention is paid and which is included in the photographed images.

9. The image evaluation apparatus according to claim 1, wherein the processor is configured to:
evaluate the photographed images by further taking into consideration the first evaluation criteria, when evaluating the photographed images, based on the second evaluation criteria.

10. The image evaluation apparatus according to claim 1, wherein the processor is configured to:
set a plurality of evaluation levels for the second evaluation criteria; and
classify and evaluate the photographed images at each evaluation level, when evaluating the photographed images, based on the second evaluation criteria.

11. The image evaluation apparatus according to claim 2, wherein the processor is configured to:
select the photographed images through evaluation based on the second evaluation criteria, only from the photographed images that have been selected through evaluation based on the first evaluation criteria.

12. The image evaluation apparatus according to claim 2, wherein the processor further comprises a storage unit that is configured to store the photographed images selected through evaluation based on the second evaluation criteria.

13. An image evaluation method, comprising the processing of:
evaluating photographed images, based on first evaluation criteria, while images are continuously photographed; and
upon completion of the continuous photography, evaluating the photographed images that have been evaluated based on the first evaluation criteria, further based on second evaluation criteria.

14. An image evaluation apparatus, comprising
a sensor unit that is configured to acquire information relating to the image evaluation apparatus; and
a processor that is configured to:
select continuously photographed images, through evaluation based on first evaluation criteria according to the information relating to the image evaluation apparatus acquired by way of the sensor unit; and
select the photographed images from the photographed images that have been selected through evaluation based on the first evaluation criteria, further through evaluation based on second evaluation criteria according to content of the photographed images.

15. The image evaluation apparatus according to claim 14, wherein the processor is configured to:
acquire a moving state of the image evaluation apparatus, acquired by way of the sensor unit;
further calculate first feature quantity, based on the moving state acquired; and
select continuously photographed images, based on the first evaluation criteria being based on the first feature quantity calculated.

16. The image evaluation apparatus according to claim 14, wherein the processor is configured to:
further calculate second feature quantity, based on predetermined analytical evaluation criteria, by analyzing the photographed images; and
select the photographed images from the photographed images that have been selected based on the first evaluation criteria, further through evaluation based on the second evaluation criteria being based on the second feature quantity calculated.

17. An image evaluation method executed by an image evaluation apparatus, the method comprising the processing of:
evaluating continuously photographed images, based on first evaluation criteria according to information acquired by way of a sensor unit that is configured to acquire information relating to the image evaluation apparatus; and
selecting the photographed images from the photographed images that have been evaluated based on the first evaluation criteria, further through evaluation based on second evaluation criteria according to content of the photographed images.
